(19) United States
(12) Patent Application Publication
(10) Pub. No.: US 2012/0048392 A1
(43) Pub. Date: Mar. 1, 2012

(54) PRESSURE RELIEF VALVE DEVICE FOR AN INFLATABLE ARTICLE

(76) Inventors: Rong-Jyh Song, Taipei (TW); Tsung-Ping Yen, Taipei (TW)

(21) Appl. No.: 12/941,746

(22) Filed: Nov. 8, 2010

(30) Foreign Application Priority Data
Aug. 30, 2010 (CN) 201020509487.3

(51) Int. Cl. F16K 15/20

(52) U.S. Cl. 137/224

(57) ABSTRACT

A pressure relief valve device includes a mount adapted to be mounted on an inflatable article, and having an abutment mount defining a valve port, a valve disc disposed outwardly of the abutment mount to be axially movable to open and close the valve port, and having a stem extending through the abutment mount for connecting a biasing member. Once internal air pressure of the article exceeds a preset pressure determined by the biasing member, the stem is forced by an excess pressure of the internal air to lift the valve disc away from the valve port so as to permit escape of the internal air out of the article through the valve port for relieving the overpressure in the article.

### CROSS-REFERENCE TO RELATED APPLICATION

This application claims priority of Chinese Utility Model Application No. 201020509487.3, filed on Aug. 30, 2010, the disclosure of which is herein incorporated by reference.

### BACKGROUND OF THE INVENTION

1. Field of the Invention

This invention relates to a valve device for an inflatable article, more particularly to a pressure relief valve device for relieving excess air pressure in an inflatable article.

2. Description of the Related Art

A conventional inflatable article is generally made from a plastic material which is prone to undesirable deformation due to an abrupt hike in the pressure of the internal air in the inflatable article, that takes place as a result of overblowing the inflatable article or exposing it to prolonged sun-heat, particularly in summer time. Hence, it is desirable to provide a pressure relief valve device to allow venting of the inflatable article once the internal air pressure exceeds a preset pressure.

### SUMMARY OF THE INVENTION

An object of the present invention is to provide a pressure relief valve device which allows automatic venting of an inflatable article once the internal air pressure exceeds a preset pressure.

According to this invention, the pressure relief valve device includes a mount, a valve, and a biasing member. The mount includes a tubular wall extending in a direction of an axis and into an inflatable chamber, and an abutment mount extending from the tubular wall radially and towards the axis to terminate at a central passage. The abutment mount has an inner major surface disposed to confront the inflatable chamber, and an outer major surface which is opposite to the inner major surface in the direction of the axis, and which has a valve seat region defining a valve port that extends through the inner major surface. The valve includes a valve disc and a stem. The valve disc is disposed outwardly of the outer major surface and is movable relative to the outer major surface in the direction of the axis between a closed position, where the valve disc is in air-tight engagement with the valve seat region to shut off the valve port, and an open position, where the valve disc is disengaged from the valve seat region to permit internal air in the inflatable chamber to escape out through the valve port so as to relieve overpressure therein. The stem has a first end connected to the valve disc, a second end spaced apart from the inner major surface, and a stem body received in, and movable relative to the central passage between a proximate position corresponding to the open position of the valve disc and a distal position corresponding to the closed position of the valve disc. The biasing member is disposed between the second end and the inner major surface to bias the stem toward the distal position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded perspective view of the preferred embodiment of a pressure relief valve device according to this invention;

FIG. 2 is a sectional view of the preferred embodiment, showing that a valve disc is in a closed position;

FIG. 3 is a perspective view of a mount of the preferred embodiment;

FIG. 4 is a perspective view of an air-tight pad of the preferred embodiment;

FIG. 5 is a perspective view of a cap of the preferred embodiment; and

FIG. 6 is a sectional view of the preferred embodiment, showing that the valve disc is in an open position.

### DETAILED DESCRIPTION OF THE PREFERRED EMBODIMENT

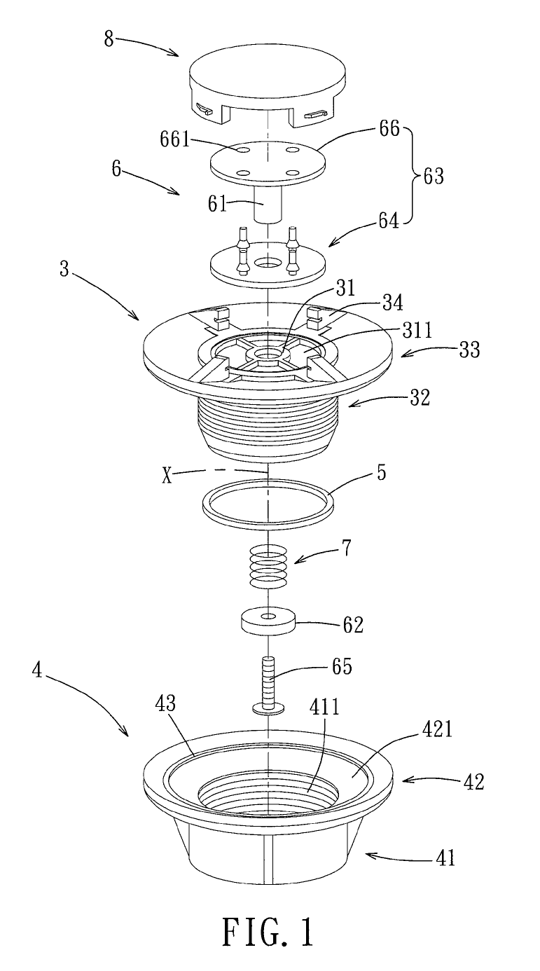

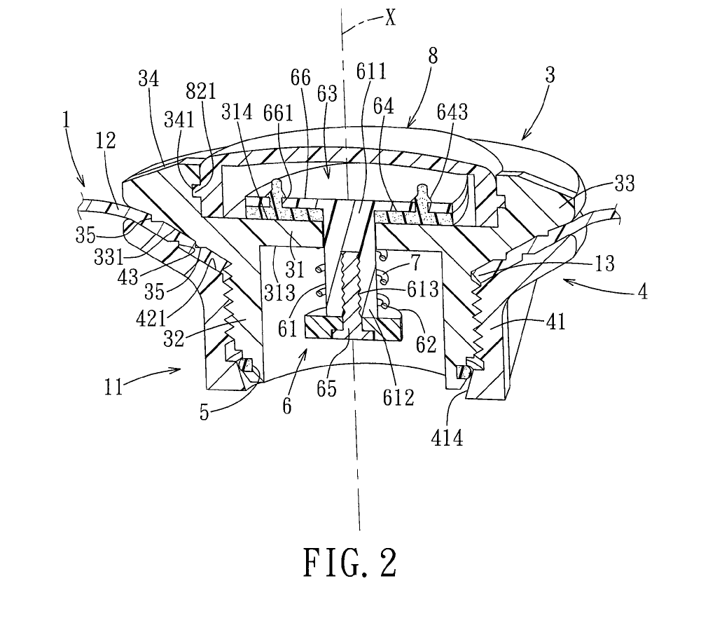

Referring to FIGS. 1 and 2, the preferred embodiment of a pressure relief valve device according to the present invention is adapted to be mounted on an inflatable article 1, such as a plastic-made swimming ring, an inflatable pillow, etc. The inflatable article 1 has an inflatable chamber 11, and an inner peripheral edge portion 12 that defines an access opening 13 for the inflatable chamber 11. The pressure relief valve device is shown to comprise a mount 3, a retaining member 4, a washer 5, a valve 6, a biasing member 7, and a cap 8.

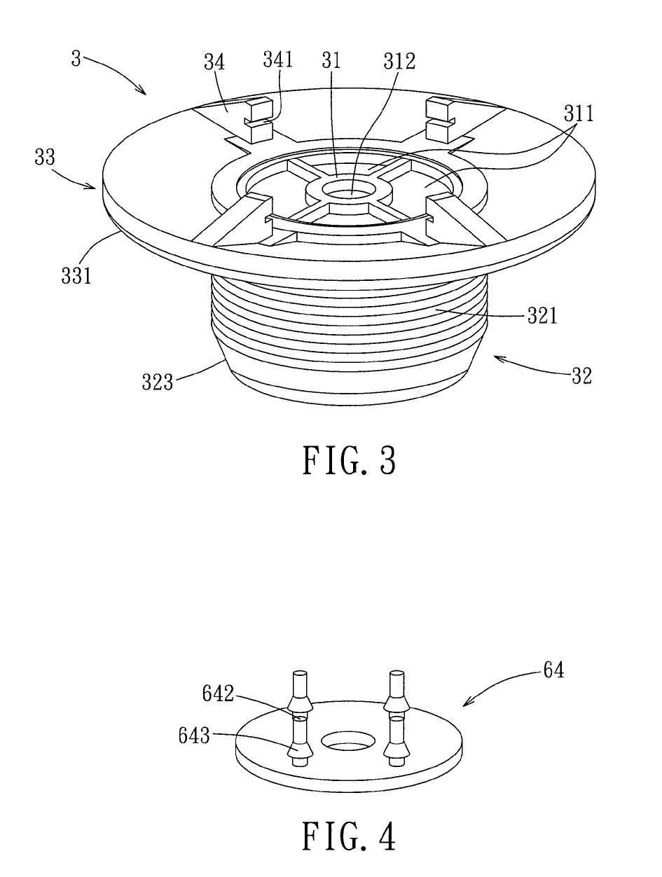

With reference to FIGS. 1 to 3, the mount 3 includes a tubular wall 32, an abutment mount 31, and an outer clamping wall 33. The tubular wall 32 extends in a direction of an axis (X) and into the inflatable chamber 11, and has an externally threaded portion 321 and an external tapered surface 323 for facilitating insertion into the access opening 13. The abutment mount 31 extends from the tubular wall 32 radially and towards the axis (X) to terminate at a central passage 312, and has an inner major surface 313 disposed to confront the inflatable chamber 11, and an outer major surface 314 which is opposite to the inner major surface in the direction of the axis (X), and which has a valve seat region defining a plurality of valve ports 311 that extends through the inner major surface 314. The number of the valve ports 311 may be only one. The outer clamping wall 33 extends outwardly and flares from the tubular wall 32, and has an outer clamping surface 331 which is formed with two surrounding serrations 35 so as to be attached tightly to the inner peripheral edge portion 12. The mount 3 further includes a plurality of retaining portions 34 which are disposed on the outer clamping wall 33, which are angularly displaced from one another about the axis (X), and which have a plurality of retaining grooves 341, respectively.

The retaining member 4 is adapted to be disposed in the inflatable chamber 11, and has a sleeve wall 41 which is formed with an internally threaded portion 411 to be sleeved on and threadedly engaged with the externally threaded portion 321 of the tubular wall 32, and an inner clamping wall 42 which has an inner clamping surface 421 configured to be attached to the inner peripheral edge portion 12 and formed with a surrounding serration 43 so as to cooperate with the outer clamping surface 331 to clamp the inner peripheral edge portion 12 when the sleeve wall 41 is threadedly engaged with the tubular wall 32. In this embodiment, once the sleeve wall 41 is fully engaged with the tubular wall 32, the surrounding serration 43 is brought to be interposed between the surrounding serrations 35. Further, the washer 5 is interposed between the tubular wall 32 and the sleeve wall 41 so as to ensure the tightening engagement therebetween. The sleeve wall 41 may be formed with an internal tapered surface 414 mating with the external tapered surface 323 of the tubular wall 32 for abutment of the washer 5 thereon.

Referring to FIGS. 1, 2 and 4, the valve 6 includes a valve disc 63 and a stem 61. The valve disc 63 is disposed outwardly of the outer major surface 314 of the abutment mount 31 and is movable relative to the outer major surface 314 in the direction of the axis (X) between a closed position, where the valve disc 63 is in air-tight engagement with the valve seat region to shut off the valve ports 311, and an open position, where the valve disc 63 is disengaged from the valve seat region to permit internal air in the inflatable chamber 11 to escape out through the valve ports 311 so as to relieve overpressure therein. The stem 61 has a first end 611 connected to the valve disc 63, a second end 612 which is opposite to the first end 611 in the direction of the axis (X), and which is spaced apart from the inner major surface 313; and a stem body 613 which is interposed between the first and second ends 611, 612, and which is received in, and movable relative to the central passage 312 between a proximate position corresponding to the open position of the valve disc 63, where the second end 612 is closer to the inner major surface 313, and a distal position corresponding to the closed position of the valve disc 63, where the second end 612 is remote from the inner major surface 313.

In this embodiment, the valve disc 63 includes a disc body 66 which is integrally formed with the first end 611 of the stem 61, and an air-tight pad 64 which is made from an elastomeric material, such as rubber, which is sleeved on the stem 61, and which abuts against the disc body 66 to thereby ensure an air-tight engagement between the valve seat region of the outer major surface 314 and the valve disc 63 in the closed position. The disc body 66 has a plurality of through holes 661 extending therethrough. The air-tight pad 64 has a plurality of protrusions 642 which respectively extend through the through holes 661, and a plurality of elastomeric barbs 643 which are respectively formed on the protrusions 642 to anchor onto the disc body 66 after being pressed through the respective through holes 661. The valve 6 further has an enlarged head 62 which is threadedly connected to the second end 612 of the stem 61 by a screw fastener 65. The biasing member 7 is disposed to abut against the enlarged head 62 and the inner major surface 313 to bias the stem 61 toward the distal position. By turning of the screw fastener 65, the distance between the enlarged head 62 and the inner major surface 313 is adjustable, thereby rendering the biasing force of the biasing member 7 to be adjustable.

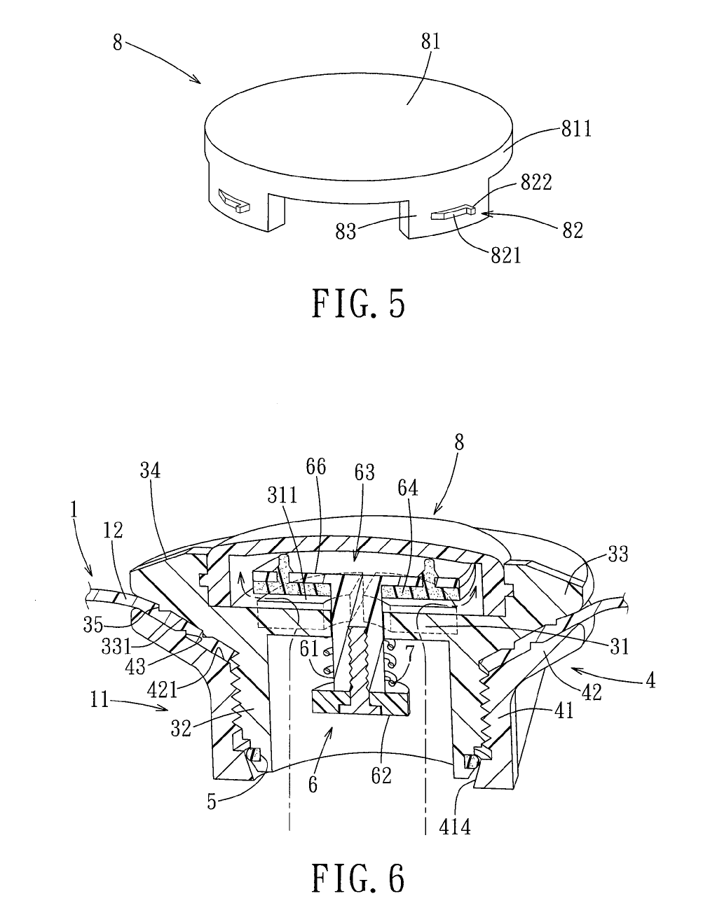

With reference to FIGS. 1, 2 and 5, the cap 8 is detachably mounted on the mount 3, and includes a cap major wall 81 mounted outwardly of and spaced apart from the valve disc 63 in the direction of the axis (X), a plurality of legs 83 extending from a periphery 811 of the cap major wall 81 to rest on the outer clamping wall 33, and a plurality of retained ribs 82 disposed on the legs 83, respectively. Each of the retained ribs 82 has a circumferentially extending portion 821 fitted in the respective retained groove 341, and a radially extending portion 822 to be retained on the respective retaining portion 34 when the legs 83 are angularly moved around the axis (X).

When the internal air pressure of the article 1 is under a preset pressure as determined by the biasing force of the biasing member 7, the stem 61 is at the distal position to hold the valve disc 63 in the closed position where the air-tight pad 64 is sealingly engaged with the valve seat region to shut off the valve ports 311, as shown in FIG. 2. When the internal air pressure of the article 1 exceeds the preset pressure, as shown in FIG. 6, the stem 61 is pressed by an excess internal air pressure against the biasing force of the biasing member 7 to the proximate position to move the valve disc 63 to the open position so as to permit escape of the internal air out of the article 1 through the valve ports 311 for relieving the overpressure in the article 1. Once the internal air pressure is decreased to the preset pressure, the valve disc 63 is moved back to the closed position by means of the biasing force of the biasing member 7. As illustrated, undesired deformation of the inflatable article 1 as a result of abrupt hike in the internal air pressure can be avoided.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A pressure relief valve device for an inflatable article which has an inflatable chamber, and an inner peripheral edge portion that defines an access opening for the inflatable chamber, comprising:
a mount including
a tubular wall extending in a direction of an axis and into the inflatable chamber, and
an abutment mount that extends from said tubular wall radially and towards the axis to terminate at a central pas sage, said abutment mount having an inner major surface disposed to confront the inflatable chamber, and an outer major surface which is opposite to said inner major surface in the direction of the axis, and which has a valve seat region defining a valve port that extends through said inner major surface;
a valve including
a valve disc which is disposed outwardly of said outer major surface and which is movable relative to said outer major surface in the direction of the axis between a closed position, where said valve disc is in air-tight engagement with said valve seat region to shut off said valve port, and an open position, where said valve disc is disengaged from said valve seat region to permit internal air in the inflatable chamber to escape out through said valve port so as to relieve overpressure therein, and
a stem having a first end connected to said valve disc, a second end which is opposite to said first end in the direction of the axis, and which is spaced apart from said inner major surface, and a stem body which is interposed between said first and second ends, and which is received in, and movable relative to said central passage between a proximate position corresponding to the open position of said valve disc, where said second end is closer to said inner major surface, and a distal position corresponding to the closed position of said valve disc, where said second end is remote from said inner major surface; and
a biasing member disposed between said second end and said inner major surface to bias said stem toward the distal position.

2. The pressure relief valve device according to claim 1, wherein said mount further includes an outer clamping wall which extends outwardly and which flares from said tubular wall and which has an outer clamping surface adapted to be attached to the inner peripheral edge portion, said pressure relief valve device further comprising a retaining member adapted to be disposed in the inflatable chamber and having a sleeve wall which is sleeved on, and in tightening engagement with said tubular wall, and an inner clamping wall which has an inner clamping surface configured to be attached to the inner peripheral edge portion so as to cooperate with said outer clamping surface to clamp the inner peripheral edge portion when said sleeve wall is tightly engaged with said tubular wall.

3. The pressure relief valve device according to claim 2, wherein said sleeve wall is configured to be threadedly engaged with said tubular wall, each of said outer and inner clamping surfaces having a serration adapted to be engaged with the inner peripheral edge portion.

4. The pressure relief valve device according to claim 3, further comprising a washer interposed between said tubular wall and said sleeve wall so as to ensure the tightening engagement therebetween.

5. The pressure relief valve device according to claim 2, wherein said valve disc includes a disc body which is integrally formed with said first end of said stem, and an air-tight pad which is sleeved on said stem and which abuts against said disc body to thereby ensure an air-tight engagement between said valve seat region and said valve disc in the closed position.

6. The pressure relief valve device according to claim 5, wherein said disc body has a plurality of through holes extending therethrough, said air-tight pad having a plurality of protrusions which respectively extend through said through holes, and a plurality of elastomeric barbs which are respectively formed on said protrusions to anchor onto said disc body after being pressed through said through holes.

7. The pressure relief valve device according to claim 2, wherein said mount has a plurality of retaining portions which are disposed on said outer clamping wall and angularly displaced from each other about the axis, and which have a plurality of retaining grooves, respectively, said pressure relief valve device further comprising:
a cap which includes a cap major wall mounted outwardly of and spaced apart from said valve disc in the direction of the axis, a plurality of legs extending from a periphery of said cap major wall, and a plurality of retained ribs which are disposed on said legs, respectively, and which are configured to be fitted and retained in said retained grooves correspondingly when said legs are angularly moved around the axis.

8. The pressure relief valve device according to claim 1, wherein said valve has an enlarged head which is threadedly connected to said second end of said stem by a screw fastener for abutment of said biasing member thereagainst so as to permit adjustability of distance between said enlarged head and said inner major surface, thereby rendering the biasing force of said biasing member to be adjustable.
